(19) United States
(12) Patent Application Publication
(10) Pub. No.: US 2026/0366962 A1
(43) Pub. Date: Nov. 19, 2026

(54) SELF-DETECTION OF MAGNETORHEALOGICAL FLUID LEAKS

(71) Applicant: GM GLOBAL TECHNOLOGY OPERATIONS LLC, Detroit, MI (US)

(72) Inventors: Brian K. Saylor, South Lyon, MI (US); Nojan Medinei, Toronto (CA); Robert Patrick Marble, White Lake, MI (US)

(73) Assignee: GM GLOBAL TECHNOLOGY OPERATIONS LLC, Detroit, MI (US)

(21) Appl. No.: 19/208,806

(22) Filed: May 15, 2025

(51) Int. Cl. G01M 17/04; B60G 13/08; B60G 17/015; B60G 17/08; G01M 3/40

(52) U.S. Cl. CPC G01M 17/04; B60G 13/08; B60G 17/0152; B60G 17/08; G01M 3/40; B60G 2202/24; B60G 2204/62; B60G 2206/41; B60G 2206/71; B60G 2500/104; B60G 2600/08; B60G 2600/73; B60G 2800/162; B60G 2800/916

(57) ABSTRACT

Devices using magnetorheological (MR) fluid and methods for operating such devices are provided. A method for operating a device using a magnetorheological (MR) fluid includes applying a mixed-frequency signal to an inductor coil of the device, wherein the mixed-frequency signal includes an operating signal component at a first frequency that is configured to generate a magnetic field to control viscosity of the MR fluid, and wherein the mixed-frequency signal includes a diagnostic signal at a second frequency, wherein the second frequency is higher than the first frequency; measuring a current flowing through the inductor coil; filtering out a high frequency component of the current; and monitoring impedance of the high frequency component of the current to identify non-optimal MR fluid behavior.

### INTRODUCTION

The technical field generally relates to a magnetorheological devices, and particularly to a controllable magnetorheological device capable of self-detection of magnetorheological fluid cavitation or leaks.

A number of devices utilize magnetorheological (MR) fluid for control. For example, vehicle suspension systems may utilize active damping devices that use MR fluid for controlling the vibrations of the body and wheel due to road disturbances imposed on the mass-spring system of the vehicle body, wheel and suspension springs. For example, active and controllable dampers may employ an MR fluid-filled cylinder and piston arrangement where the viscosity of the MR fluid may be changed by the introduction of a magnetic field.

It would be desirable to develop reliable systems and methods for monitoring the MR fluid to determine whether the MR fluid is leaking or experiencing cavitation, such as due to low gas pressure. Further, it would be desirable to monitor the MR fluid, without requiring use of additional sensors or structures. Furthermore, other desirable features and characteristics of the present disclosure will become apparent from the subsequent detailed description and the appended claims, taken in conjunction with the accompanying drawings and the foregoing introduction.

### SUMMARY

In one embodiment, a method for operating a device using a magnetorheological (MR) fluid includes applying a mixed-frequency signal to an inductor coil of the device, wherein the mixed-frequency signal includes an operating signal component at a first frequency that is configured to generate a magnetic field to control viscosity of the MR fluid, and wherein the mixed-frequency signal includes a diagnostic signal at a second frequency, wherein the second frequency is higher than the first frequency; measuring a current flowing through the inductor coil; filtering out a high frequency component of the current; and monitoring impedance of the high frequency component of the current to identify non-optimal MR fluid behavior.

In certain embodiments of the method, the non-optimal MR fluid behavior is a loss of MR fluid.

In certain embodiments of the method, the non-optimal MR fluid behavior is cavitation of the MR fluid.

In certain embodiments of the method, the first frequency operating signal component is less than 5 kHz; and the second frequency of the diagnostic signal is greater than 10 kHz.

In certain embodiments of the method, monitoring impedance of the high frequency component of the current to identify non-optimal MR fluid behavior includes comparing a response to a baseline value.

In certain embodiments of the method, monitoring impedance of the high frequency component of the current to identify non-optimal MR fluid behavior includes determining whether the impedance matches an expected response.

In certain embodiments of the method, the expected response is generated based on system information selected from position, speed, current, and temperature.

In certain embodiments of the method, monitoring impedance of the high frequency component of the current to identify non-optimal MR fluid behavior includes determining that the impedance does not match an expected response; adding a count to a count total; determining that the count total meets threshold; and signaling to an operator that a potential fault exists in the MR fluid device.

In certain embodiments of the method, monitoring impedance of the high frequency component of the current to identify non-optimal MR fluid behavior includes: determining that the impedance does not match an expected response; adding a count to a count total; determining that the count total does not meet threshold; and continuing monitoring impedance of the high frequency component of the current to identify non-optimal MR fluid behavior.

In another embodiment, a magnetorheological (MR) fluid device is provided and includes a magnetorheological (MR) fluid; an inductor coil configured to apply a magnetic field to the MR fluid; a low frequency operating signal generator module; a high frequency operating signal generator module; a circuit configured to apply a mixed-frequency signal to the inductor coil, wherein the mixed-frequency signal includes an operating signal component at a first frequency that is configured to generate the magnetic field to control viscosity of the MR fluid, and wherein the mixed-frequency signal includes a diagnostic signal at a second frequency, wherein the second frequency is higher than the first frequency; a current detector configured to measure a current flowing through the inductor coil; a high pass filter configured to filter out a high frequency component of the current; and a module for monitoring impedance of the high frequency component of the current to identify non-optimal MR fluid behavior.

In certain embodiments of the device, the non-optimal MR fluid behavior is a loss of MR fluid.

In certain embodiments of the device, the non-optimal MR fluid behavior is cavitation of the MR fluid.

In certain embodiments of the device, the first frequency operating signal component is less than 5 kHz; and the second frequency of the diagnostic signal is greater than 10 kHz.

In certain embodiments of the device, the module for monitoring impedance of the high frequency component of the current to identify non-optimal MR fluid behavior is configured to compare a response to a baseline value.

In certain embodiments of the device, the module for monitoring impedance of the high frequency component of the current to identify non-optimal MR fluid behavior is configured to determine whether the impedance matches an expected response.

In certain embodiments of the device, the module for monitoring impedance of the high frequency component of the current to identify non-optimal MR fluid behavior is configured to generate the expected response based on system information selected from position, speed, current, and temperature.

In certain embodiments of the device, the module for monitoring impedance of the high frequency component of the current to identify non-optimal MR fluid behavior is configured to: determine that the impedance does not match an expected response; add a count to a count total; determine that the count total meets threshold; and signal to an operator that a potential fault exists in the MR fluid device.

In certain embodiments of the device, the module for monitoring impedance of the high frequency component of the current to identify non-optimal MR fluid behavior is configured to: determine that the impedance does not match an expected response; add a count to a count total; determine that the count total does not meet threshold; and continue monitoring impedance of the high frequency component of the current to identify non-optimal MR fluid behavior.

In another embodiment, a vehicle is provided and includes a magnetorheological (MR) fluid device including a magnetorheological (MR) fluid; an inductor coil configured to apply a magnetic field to the MR fluid; a low frequency operating signal generator module; a high frequency operating signal generator module; a circuit configured to apply a mixed-frequency signal to the inductor coil, wherein the mixed-frequency signal includes an operating signal component at a first frequency that is configured to generate the magnetic field to control viscosity of the MR fluid, and wherein the mixed-frequency signal includes a diagnostic signal at a second frequency, wherein the second frequency is higher than the first frequency; a current detector configured to measure a current flowing through the inductor coil; a high pass filter configured to filter out a high frequency component of the current; and a module for monitoring impedance of the high frequency component of the current to identify non-optimal MR fluid behavior.

In certain embodiments of the vehicle, the MR fluid device is a damper.

### DESCRIPTION OF THE DRAWINGS

The present disclosure will hereinafter be described in conjunction with the following drawing figures, wherein like numerals denote like elements, and wherein:

FIG. 1 depicts an exemplary vehicle that includes a device using a magnetorheological (MR) in accordance with aspects of the present disclosure;

FIG. 2 depicts an isometric view of a portion of FIG. 1 in accordance with aspects of the present disclosure;

FIG. 3 illustrates an embodiment of a magnetorheological fluid device in accordance with aspects of the present disclosure;

FIG. 4 illustrates control modules for the embodiment of FIG. 3 in accordance with aspects of the present disclosure;

FIG. 5 is a graph illustrating effects of magnetorheological fluid leaks in accordance with aspects of the present disclosure; and

FIG. 6 is a flowchart illustrating a method for operating a magnetorheological fluid device with self-detection of leaks in accordance with aspects of the present disclosure.

### DETAILED DESCRIPTION

The following detailed description is merely exemplary in nature and is not intended to limit the application and uses of embodiments herein. Furthermore, there is no intention to be bound by any expressed or implied theory presented in the preceding introduction, summary or the following detailed description.

As used herein, the term module refers to any hardware, software, firmware, electronic control unit or component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of automated driving systems including cruise control systems, automated driver assistance systems and autonomous driving systems, and that the vehicle system described herein is merely one example embodiment of the present disclosure.

Finally, for the sake of brevity, conventional techniques and components related to vehicle mechanical parts and other functional aspects of the system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment. It should also be understood that the figures are merely illustrative and may not be drawn to scale.

Additionally, the following description refers to elements or features being “connected” or “coupled” together. As used herein, “connected” may refer to one element/feature being directly joined to (or directly communicating with) another element/feature, and not necessarily mechanically. Likewise, “coupled” may refer to one element/feature being directly or indirectly joined to (or directly or indirectly communicating with) another element/feature, and not necessarily mechanically. However, it should be understood that, although two elements may be described below, in one embodiment, as being “connected,” in alternative embodiments similar elements may be “coupled,” and vice versa. Thus, although the schematic diagrams shown herein depict example arrangements of elements, additional intervening elements, devices, features, or components may be present in an actual embodiment.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

In typical magnetorheological (MR) fluid devices, no actual measurements of loss of MR fluid is performed while in use. Instead, the operator either must notice a change in performance of the MR fluid device, such as a change in ride or handling in the case of a vehicle damper or shocks, or a service technician discovers the leak during inspection.

Early detection of loss of MR fluid can alert an operator to a leak. Embodiments herein provide for early detection of a loss of MR fluid, and may notify an operator before actual performance loss is detected or becomes a handling issue with a vehicle. MR dampers with a full loss of fluid are a compromise to ride and handling, thus early detection and notification may avoid handling issues. While described in relation to a damper or shock absorber, embodiments herein may be applied to any system that utilizes MR fluid.

Embodiments herein provide for the addition of a high frequency diagnostic signal on top of the low frequency operating signal that is currently used to control operation of the MR fluid device. A high pass filter may be used to isolate the high frequency current corresponding to the high frequency diagnostic signal component. The high frequency current may be monitored and analyzed to detect MR fluid loss, such as via a leak, or to detect cavitation.

Embodiments of the present disclosure offer advantages over the existing art, though it is understood that other embodiments may offer different advantages, not all advantages are necessarily discussed herein, and no particular advantage is required for all embodiments.

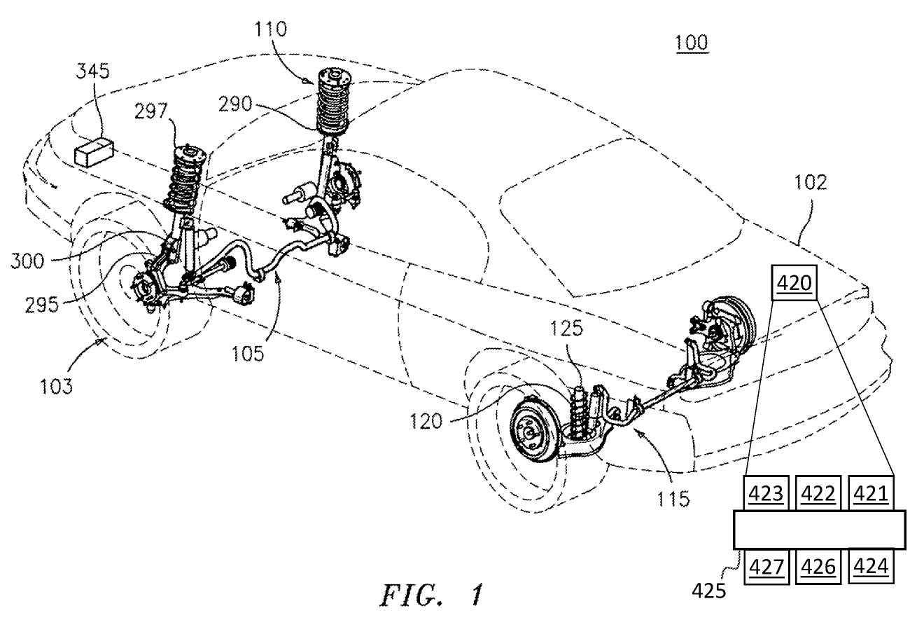

FIG. 1 is an exemplary embodiment of a vehicle 100 having a body 102, a set of wheels 103, a front suspension system 105 with a front strut 110, and a rear suspension system 115 having a rear spring 120 and magnetorheological fluid (MR) device 125, such as a rear shock absorber 125.

As depicted in FIG. 1, the vehicle 100 further includes a control module 420 in accordance with exemplary implementations. In various implementations, the vehicle 100 comprises an automobile, such as any one of a number of different types of automobiles, such as, for example, a sedan, a wagon, a truck, sport utility vehicle (SUV), or the like. In certain implementations, the vehicle 100 may also comprise a motorcycle or other vehicle, such as aircraft, spacecraft, watercraft, and so on, and/or one or more other types of mobile platforms (e.g., a robot and/or another mobile platform).

In yet other implementations, the magnetorheological fluid (MR) device 125 and control module 420 may instead be part of and/or coupled to any number of other types of platforms and/or other systems, moving or non-moving, such as a building, infrastructure, secondary use, home power, non-automotive, and/or other platforms and/or other systems.

As depicted in FIG. 1, in various implementations, the control module 420 comprises a computer system, and includes a processor 421, a memory 422, an interface 423, a storage device 424, and a computer bus 425.

The processor 421 performs the computation and control functions of the control module 420, and may comprise any type of processor or multiple processors, single integrated circuits such as a microprocessor, or any suitable number of integrated circuit devices and/or circuit boards working in cooperation to accomplish the functions of a processing unit. During operation, the processor 421 executes one or more programs 426 contained within the memory 422 and, as such, controls the general operation of the control module 420 and the computer system of the control module 420, generally in executing the processes described herein.

The memory 422 can be any type of suitable memory, including various types of non-transitory computer readable storage medium. In certain examples, the memory 422 is located on and/or co-located on the same computer chip as the processor 421. In the depicted implementation, the memory 422 stores the above-referenced program 426 along with stored values 427 (e.g., look-up tables, thresholds, and/or other values with respect to control of operations described herein).

The interface 423 allows communication to the computer system of the control module 420, for example from a system driver and/or another computer system, and can be implemented using any suitable method and apparatus. In one implementation, the interface 423 obtains the various data from a sensor array, among other possible data sources. The interface 423 can include one or more network interfaces to communicate with other systems or components. The interface 423 may also include one or more network interfaces to communicate with technicians, and/or one or more storage interfaces to connect to storage apparatuses, such as the storage device 424.

The storage device 424 can be any suitable type of storage apparatus, including various different types of direct access storage and/or other memory devices. In one exemplary implementation, the storage device 424 comprises a program product from which memory 422 can receive a program 426 that executes one or more implementations of one or more processes of the present disclosure. In another exemplary implementation, the program product may be directly stored in and/or otherwise accessed by the memory 422 and/or a disk, such as that referenced below.

The bus 425 serves to transmit programs, data, status and other information or signals between the various components of the computer system of the control module 420. The bus 425 can be any suitable physical or logical means of connecting computer systems and components. This includes, but is not limited to, direct hard-wired connections, fiber optics, infrared and wireless bus technologies. During operation, the program 426 is stored in the memory 422 and executed by the processor 421.

It will be appreciated that while this exemplary implementation is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 421) to perform and execute the program.

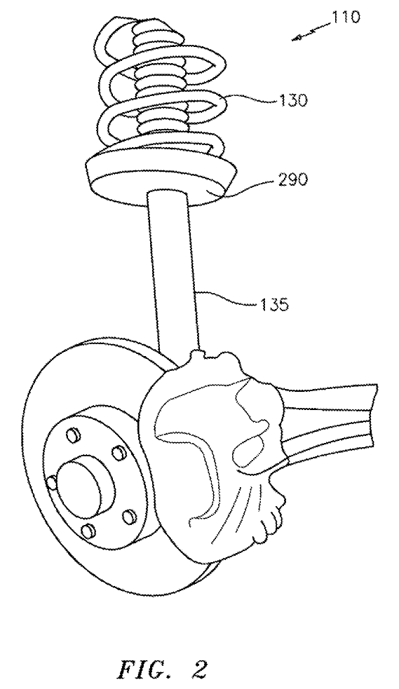

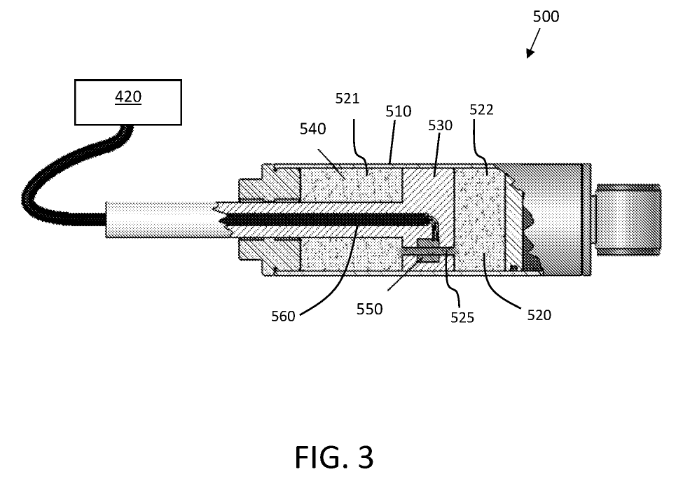

Referring to FIG. 2, front strut 110 includes a front spring 130 and a front shock absorber 135. In accordance with certain embodiments, shock absorbers 125 and 135 may separately be or may both be magnetorheological fluid (MR) dampers, such as that depicted in FIG. 3.

Embodiments herein may use any one of several different types of MR fluid devices 125, 135 depending on the packaging space.

FIG. 3 illustrates an embodiment of a magnetorheological fluid device 500 or MR fluid device 500, which may be provided as damper 125, 135 or in another system. As shown, device 500 includes a housing 510, such as a cylinder 510, defining an inner chamber 520. A piston head 530 is located within the chamber 520 for axial motion therein. As shown, the piston head 530 divides the chamber 520 into a first portion 521 and a second portion. A channel or orifice 525 is formed in the piston head 530.

As further illustrated, a magnetorheological (MR) fluid 540 is received within, and fills, the inner chamber 520, including first portion 521 and second portion 522. The magnetorheological (MR) fluid 540 may flow through the orifice 525 between the first portion 521 and second portion 522.

As further shown, an inductor coil 550 surrounds the orifice 525. Further, a circuit 560 is electrically connected to the inductor coil 550 and interconnects to the control module 420.

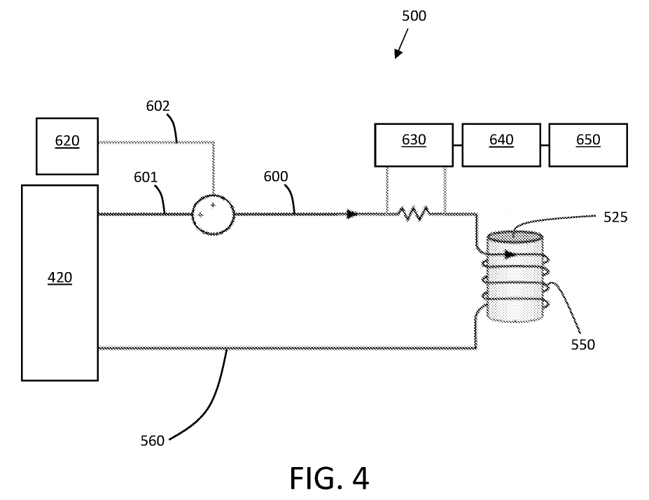

Cross-referencing FIGS. 3 and 4, the control module 420 in device 500 may be configured to apply a low frequency operating signal component 601 in order to generate a magnetic field at the orifice 525 to control shear properties of the MR fluid 540 (viscosity) in the orifice 525. For example, the control module 420 generates a low frequency operating signal component 601 (typically less than 5 kHz, such as from 0.1 to 1 kHz) and delivers it via circuit 560 to the inductor coil 550. The inductor coil 550, positioned around the orifice 525, converts the electrical signal into a corresponding magnetic field. This magnetic field interacts with the magnetorheological (MR) fluid 540 flowing through the orifice 525.

The MR fluid 540 contains ferromagnetic particles suspended in a carrier liquid such as oil. When the magnetic field from the inductor coil 550 is applied, the particles align along the field lines. This alignment increases the viscosity of the MR fluid 540 locally within the orifice 525, transitioning it from a liquid-like state to a semi-solid state. The degree of alignment and resulting viscosity depend on the strength of the magnetic field.

A higher current in the low frequency operating signal component 601 strengthens the magnetic field produced by the inductor coil 550. This enhances particle alignment in the MR fluid 540, increasing viscosity within the orifice 525. Higher viscosity restricts fluid flow, reducing flow rate or increasing resistance to flow. A lower current in the low frequency operating signal component 601 weakens the magnetic field, reducing particle alignment. This decreases the viscosity of the MR fluid 540, allowing it to flow more freely through the orifice 525, increasing the flow rate or reducing resistance.

The low frequency nature of signal component 601 allows real-time modulation of the magnetic field, enabling rapid viscosity adjustments (within milliseconds) to control flow precisely.

A current detector 630 may be used to monitor the current in the circuit 560. While illustrated as a stand-alone unit, the current detector 630 may be a current detection module incorporated in the control module 420.

The control module 420 uses the current-modulated signal component 601 to dynamically adjust the magnetic field, tailoring the MR fluid’s viscosity in the orifice 525 to achieve desired flow characteristics. In this manner, the device 500 provides analog control in allowing or resisting axial movement of the piston head 530 within the cylinder 510.

Embodiments herein utilize the existing control module 420 and circuit 560 to further provide for detection of leaks of the MR fluid 540 or for detection of cavitation within the MR fluid 540, such as due to low gas pressure.

Specifically, as shown in FIG. 4, a high frequency signal component 602 may be added to the low frequency signal component 601 to form a mixed-frequency composite signal 600 that is applied to the inductor coil 550. For example, a high frequency test generator 620 may generate the high frequency diagnostic signal component 602. The high frequency diagnostic signal component 602 is at a frequency higher than the low frequency signal component 601. For example, the high frequency diagnostic signal component 602 may be at least 10 kHz, such as from 30 to 50 kHz. While illustrated as a stand-alone unit, the high frequency test generator 620 may be a high frequency test generator module incorporated in the control module 420.

The low frequency operating signal component 601, generated by the control module 420 and delivered via circuit 560 to the inductor coil 550, produces a selectively variable magnetic field around the orifice 525. This magnetic field interacts with the magnetorheological (MR) fluid 540, which contains ferromagnetic particles suspended in a carrier liquid. The field causes the particles to align along the magnetic field lines. This alignment increases the viscosity of the MR fluid 540 locally within the orifice 525, transitioning it from a liquid-like to a semi-solid state. The degree of particle alignment, and thus the viscosity, is proportional to the magnetic field strength, which is controlled by the current amplitude of the low frequency signal component 601. By varying the current, the control module 420 precisely adjusts the MR fluid’s viscosity, controlling the flow rate or resistance through the orifice 525. Higher currents increase viscosity, restricting flow, while lower currents decrease viscosity, allowing freer flow.

The high frequency diagnostic signal component 602, also applied to the inductor coil 550 as part of the composite signal 600, generates a rapidly oscillating magnetic field. This field may not significantly affect the viscosity of the MR fluid 540 due to two key factors: particle response time and low amplitude. For example, the ferromagnetic particles in the MR fluid 540 have a finite response time (on the order of milliseconds) to align with an applied magnetic field. The high frequency oscillations of the diagnostic signal component 602 are too rapid for the particles to follow. As a result, the particles cannot align, and the viscosity remains unaffected by this component. Also, the high frequency diagnostic signal component 602 may be designed with a low amplitude compared to the low frequency signal component 601 to minimize influence on the MR fluid 540. The weak magnetic field produced is sufficient for diagnostic purposes (e.g., impedance measurement) but insufficient to induce significant particle alignment or viscosity changes.

Thus, the high frequency component 602 interacts with the MR fluid 540 and coil 550 primarily to probe electrical properties (e.g., impedance) for diagnostics, without altering the fluid’s rheological behavior.

The current detector 630, connected to circuit 560, monitors the current flowing through the inductor coil 550. A high pass filter 640 connected to or within the current detector 630 is configured to isolate the high frequency current corresponding to the diagnostic signal component 602 by attenuating the low frequency current from the operating signal component 601. The high pass filter 640 allows frequencies above a set cutoff (e.g., greater than 2 kHz) to pass, extracting the high frequency current for analysis.

The impedance of the inductor coil 550 at the high frequency of the diagnostic signal component 602, i.e., the high frequency impedance, is influenced by the properties of the MR fluid 540 and the surrounding system. The current detector 630 analyzes the high frequency current to determine the coil’s impedance at the high frequency, which is calculated as Z=V/I, where V is the voltage of the high frequency component 602, and I is the filtered high frequency current.

In a properly functioning system, the MR fluid 540 fills the chamber 520 and the orifice 525, and the ferromagnetic particles in the MR fluid 540 contribute to the coil’s inductance and impedance. The high frequency impedance may exhibit a stable baseline value, reflecting the expected electrical properties of the coil and fluid.

When there is a leak in the MR fluid 540 (e.g., MR fluid loss from the chamber 520), the composition or volume of the fluid in the coil’s vicinity changes. This alters the coil’s inductance (due to reduced particle density or altered magnetic permeability) and, consequently, its high frequency impedance. A significant deviation in impedance (e.g., a decrease due to less MR fluid or an increase due to air ingress) indicates a potential leak.

In certain embodiments, the control module 420 or current detector 630 compares the measured impedance to a reference range. Anomalies, such as a sudden or sustained shift outside this range, trigger a diagnostic alert for a possible MR fluid leak. Thus, the device uses a current detector 630 and high pass filter 640 to isolate the high frequency current, and impedance analysis detects MR fluid leaks by identifying deviations from expected values, ensuring system reliability.

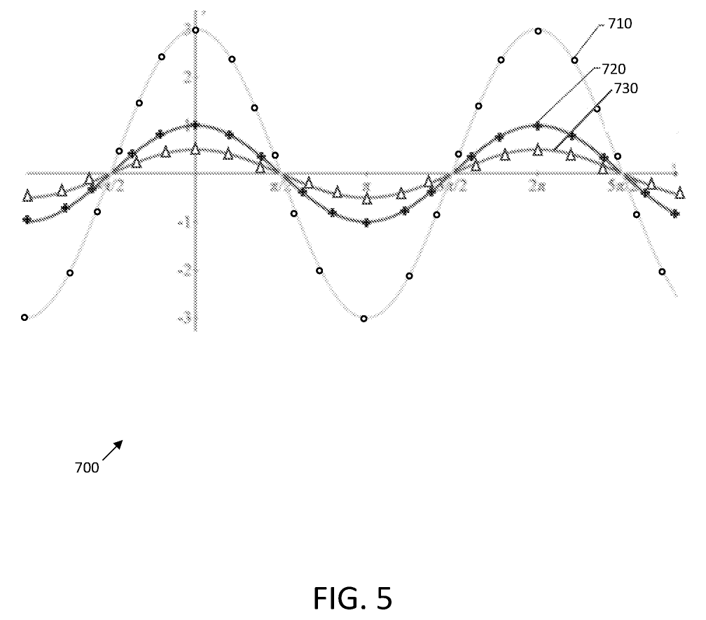

FIG. 5 is a graph 700 illustrating the measured impedance when the MR fluid is in normal operating condition, when the MR fluid is experiencing a small leak or cavitation, or when the MR fluid is severely depleted by a large leak.

Specifically, in FIG. 5, the Y-axis represents the measured impedance and the X-axis represents time. As shown, three sine waves represent the measured impedance in time of three different conditions of the MR fluid 540.

In FIG. 5, line 710 represents the measured impedance when the chamber 520 is full of MR fluid 540 and when the MR fluid 540 is a homogeneous suspension of ferromagnetic particles. Specifically, in such conductions, a constant, maximum, amount of ferromagnetic particles are in and traveling through magnetic field at the orifice 525. As shown, the measured impedance line 710 under such conditions is a sine wave having a maximum amplitude, higher than the lines 720 and 730 described below.

In FIG. 5, line 720 represents the measured impedance when the MR fluid passing through the orifice 525 includes a small volume that is void of ferromagnetic particles.

For example, when MR fluid 540 leaks from the chamber 520, a bubble of gas, such as air, may form. Specifically, a leak of the MR fluid 540 (e.g., through seals or damaged components) may reduce the internal fluid volume, creating a partial vacuum or lower pressure within the chamber. This may cause air or external gases to be drawn into the chamber through the leak point, leading to the formation of bubbles. When a bubble passes through the orifice 525, the amount of ferromagnetic particles located in the magnetic field decreases, resulting in line 720 in the graph of FIG. 5. As shown, the measured impedance line 720 is a sine wave having an intermediate amplitude, as compared to lines 710 and line 730 described below.

Also, cavitation in a magnetorheological (MR) fluid may occur when localized low-pressure regions within the fluid cause the formation and collapse of vapor or gas bubbles. Again, when such bubbles pass through the orifice 525, the amount of ferromagnetic particles located in the magnetic field decreases, resulting in line 720 in the graph of FIG. 5.

Further, if the MR fluid device 500 has been stationary and unused for a long period of time, the ferromagnetic particles suspended in the carrier liquid may fall out of suspension. As a result, a portion of carrier oil that is void of ferromagnetic particles may pass through the orifice, and the measured impedance line 720 may result. Typically, a short period of movement and use of the MR fluid device 500 causes the ferromagnetic particles to again become suspended in the carrier oil, such that normal impedance measurements (such as line 710) resume.

In FIG. 5, line 730 represents the measured impedance when a severe leak, due to a fast rate of loss or a slow leak occurring over a long duration, occurs and the amount of gas, i.e., the number of bubbles, increases such that the amount of ferromagnetic particles located in the magnetic field is low. For example, at a fully depleted condition, the orifice 525 has the least amount of ferrous core in the magnetic field. Thus, line 730 results when the MR fluid 540 is depleted. As shown, the measured impedance line 730 is a sine wave having a lowest amplitude, as compared to lines 710 and 720.

Embodiments herein provide systems and methods for monitoring impedance, as depicted in FIG. 5, to identify a leak of MR fluid 540, to identify the severity of a leak of MR fluid 540, and/or to identify cavitation of the MR fluid 540. False positive indications such as those resulting from a long period of non-use may be disregarded by methods herein.

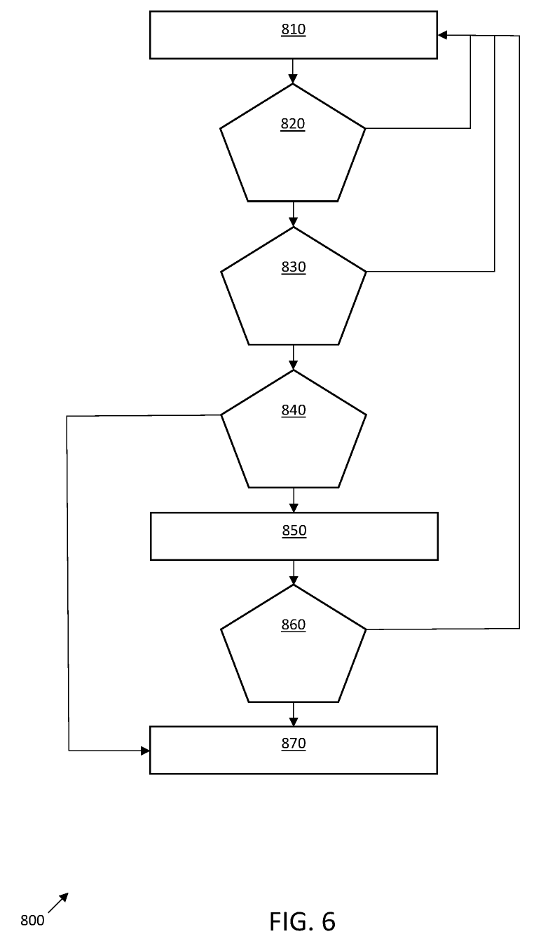

FIG. 6 is a flow chart illustrating a method 800 for operating a device 500 using a magnetorheological (MR) fluid 540. Operations and queries of the method 800 may be performed by the control module 420 generally, and by the processor 421 specifically.

Method 800 may include operation 810, where impedance at the inductor coil 550 is monitored and measured, as described above. Operation 810 may be performed continuously and automatically upon activation and use of the MR fluid device 500. For example, the control module 420, and specifically the processor 421 of the control module 420, may activate application of high frequency signal component 602 and low frequency signal component 601 in the mixed-frequency composite signal 600 to the inductor coil 550 at operation 810. Operation 810 may include applying a mixed-frequency signal to an inductor coil of the device, wherein the mixed-frequency signal includes an operating signal component at a first frequency that is configured to generate a magnetic field to control viscosity of the MR fluid, and wherein the mixed-frequency signal includes a diagnostic signal at a second frequency, wherein the second frequency is higher than the first frequency; measuring a current flowing through the inductor coil; and filtering out a high frequency component of the current.

At query 820, the processor 421 determines whether the measured impedance matches the expected result or response. For example, in certain embodiments, the expected response may be line 710 of FIG. 5, or may be a measurement or sequence of measurements on or near line 710 of FIG. 5.

For a known input, high frequency signal/DC excitation, the system will have a characterized response, i.e., a baseline value. The control module 420 may identify the expected response based on system information, including, for example, position, speed, current temperature, or other data. Further, the control module 420 may identify the expected response based on a historical response profile maintained by the control module 420. If the measured impedance changes compared to the baseline value of the expected response, then it is possible that a fault may be identified. Operation 820 may include identifying non-optimal MR fluid behavior from the monitored impedance of the high frequency component of the current. In other words, operation 820 may monitor impedance of the high frequency component of the current to parameterize MR fluid behavior.

When query 820 determines that the measured impedance matches the expected response, then method 800 continues at operation 810 with measuring impedance at the inductor coil 550.

When query 820 determines that the measured impedance does not match the expected response, then a fault may be possible and method 800 continues at query 830.

At query 830, method 800 includes determining whether the MR fluid device 500 is recently in use after a long rest period. For example, the control module 420, including the processor 421, may determine how much time has passed since the last time the MR fluid device 500 was used, i.e., how much time has passed since the vehicle 100 was driven. A threshold period of time may be defined based on vehicle and environmental conditions. Query 830 determines if the threshold period of time, or an amount of time greater than the threshold period of time, has passed since the last time the MR fluid device 500 was in use.

When query 830 finds that at least the threshold period of time has passed since the last time the MR fluid device 500 was in use, then a false positive indicative of ferromagnetic particle settling may be noted and method 800 continues at operation 810 with measuring impedance at the inductor coil 550. A record of the false positive may be stored in the control module 420 for diagnostic use by a service technician.

When query 830 finds that the threshold period of time has not passed since the last time the MR fluid device 500 was in use, then a fault may be indicated and method 800 continues at query 840.

At query 840, the processor 421 determines whether a difference between the measured impedance and the expected response exceeds a magnitude threshold.

For example, query 840 may distinguish a small leak from a severe leak, such as the measured impedance represented by measured impedance line 720 of FIG. 5, indicative of a small MR fluid leak or cavitation, or the measured impedance line 730 of FIG. 5, indicative of a severe leak.

In certain embodiments, the magnitude threshold of the difference may be set to a value based on MR fluid device, MR fluid behavior, temperature and/or other operating conditions. For example, the magnitude threshold may be set as a percentage of the maximum measured impedance (indicated by line 710).

When query 840 determines that the difference between the measured impedance and the expected response exceeds a magnitude threshold, then a severe MR fluid leak is indicated and method 800 continues at operation 870 with signaling a potential fault to the vehicle operator. For example, an alert and message indicating a need for servicing may be communicated to the vehicle operator. A record of the measured impedance may be stored in the control module 420 for evaluation by a service technician.

When query 840 determines that the difference between the measured impedance and the expected response does not exceed a magnitude threshold, then a small MR fluid leak may be indicated and method 800 may continue at operation 850 with adding a count to verify the fault. Specifically, the control module 420 adds a count to a total count of fault indications at operation 850. The total count and record of measured impedance may be stored in the control module 420 for diagnostic evaluation by a service technician while servicing the vehicle.

Method 800 then continues at query 860 which queries whether the additional small fault indicates need for service.

For example, query 860 may evaluate the total number of faults counted at operation 850 during a drive, or during a specified number of most recent drives, to determine whether a maximum number is exceeded.

Additionally or alternatively, query 860 may evaluate whether the fault is sustained, for example, whether a fault is repeated within a specified duration of time.

Additionally or alternatively, query 860 may evaluate whether the fault and recent faults present a pattern indicative of a specific fault.

Additionally or alternatively, query 860 may evaluate whether the magnitude of the difference whether or a change in the magnitude of the difference is indicative of a serious fault.

The control module 420 may evaluate other properties of the measured impedance to determine whether the measured impedance or history of measured impedance indicates a service need.

Thus, the control module 420 may include or operate a scalable detection module to detect whether the record of the measured impedance indicates a need for servicing of the MR fluid device 500 at query 860.

When query 860 determines that there is not a present need for service, then method 800 continues at operation 810 with measuring impedance at the inductor coil 550.

When query 860 determines that there is a present need for service, then method 800 may continue at operation 870 with signaling a potential fault to the vehicle operator. For example, an alert and message indicating a need for servicing may be communicated to the vehicle operator. A record of the measured impedance may be stored in the control module 420 for evaluation by a service technician.

As described herein, embodiments measure and analyze impedance at an inductor coil that is surrounded by magnetorheological fluid to detect when there is full MR fluid, partial MR fluid, cavitating MR fluid, or depleted MR fluid (full loss of MR fluid) around the inductor coil. Based on the physics of a ferrous core versus an air core within an electromagnet coil, the impedance increases when a high frequency alternating current (AC) is applied because the AC current has to perform additional work to the iron core by changing the magnetic poles of each portion of the iron core. When a high frequency is applied to a core having less ferrous material, the impedance of the circuit decreases.

In certain embodiments, the core is defined by the chamber orifice. Thus, in normal operation the core is formed by MR fluid. A core may have less ferrous material due to air bubbles present in the core that result from an MR fluid loss or from cavitation. A core may have no ferrous material due to a total loss of MR fluid, resulting in the lowest impedance possible. Embodiments herein add a high frequency signal to the inductor coil and measure the impedance at the high frequency to identify impedance variation resulting from MR fluid “gaps”. The impedance can be measured by applying a known high frequency voltage and measuring the consumed current at that same frequency. When MR fluid is lost, the high frequency measured current will decrease. The high frequency additional signal can be applied to the MR coil when the parts are starting up and not functioning or overlaid to a known constant DC or very low frequency normal excitation. Measuring the expected current consumption of the circuit filtered to the excitation frequency can identify the ferromagnetic properties of the core of the coil. It is noted that if the MR fluid sits for long periods, the ferrous material can settle slightly out of suspension. Therefore, embodiments may calibrate a threshold of loss of ferrous properties to ignore long enough for the fluid to get re-agitated. In other words, false indications of MR fluid loss due to settling may be ignored.

Certain embodiments herein use a MR inductor coil at a higher frequency excitation to determine High Frequency (HF) Impedance using MR fluid as the core.

Certain embodiments herein use a High Frequency Impedance of MR Coil to detect loss of fluid in core of inductor.

Certain embodiments herein use HF inductance detection of missing fluid to alert the operator of MR fluid loss.

Certain embodiments herein use a frequency outside of the normal operating range of the MR fluid device to isolate missing ferrous material in the core to indicate a fault.

Certain embodiments herein use an HF generator and HF filter to only monitor the ferromagnetic properties in the core of MR fluid.

Certain embodiments herein separate the normal operation versus fluid loss detection through the use of separate, distinct signal frequencies.

It will be appreciated that the MR fluid devices, vehicles, and methods may vary from those depicted in the Figures and described herein. It will similarly be appreciated that the operations of the methods may differ from that depicted in the Figures, and/or that various operations of the methods may occur concurrently and/or in a different order than that depicted and/or described above in connection therewith.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for operating a device using a magnetorheological (MR) fluid, the method comprising:
applying a mixed-frequency signal to an inductor coil of the device, wherein the mixed-frequency signal includes an operating signal component at a first frequency that is configured to generate a magnetic field to control viscosity of the MR fluid, and wherein the mixed-frequency signal includes a diagnostic signal at a second frequency, wherein the second frequency is higher than the first frequency;
measuring a current flowing through the inductor coil;
filtering out a high frequency component of the current; and
monitoring impedance of the high frequency component of the current to identify non-optimal MR fluid behavior.

2. The method of claim 1, wherein the non-optimal MR fluid behavior is a loss of MR fluid.

3. The method of claim 1, wherein the non-optimal MR fluid behavior is cavitation of the MR fluid.

4. The method of claim 1, wherein the first frequency operating signal component is less than 5 kHz; and the second frequency of the diagnostic signal is greater than 10 kHz.

5. The method of claim 1, wherein monitoring impedance of the high frequency component of the current to identify non-optimal MR fluid behavior comprises comparing a response to a baseline value.

6. The method of claim 1, wherein monitoring impedance of the high frequency component of the current to identify non-optimal MR fluid behavior comprises:
determining whether the impedance matches an expected response.

7. The method of claim 6, wherein the expected response is generated based on system information selected from position, speed, current, and temperature.

8. The method of claim 1, wherein monitoring impedance of the high frequency component of the current to identify non-optimal MR fluid behavior comprises:
determining that the impedance does not match an expected response;
adding a count to a count total;
determining that the count total meets threshold; and
signaling to an operator that a potential fault exists in the MR fluid device.

9. The method of claim 1, wherein monitoring impedance of the high frequency component of the current to identify non-optimal MR fluid behavior comprises:
determining that the impedance does not match an expected response;
adding a count to a count total;
determining that the count total does not meet threshold; and
continuing monitoring impedance of the high frequency component of the current to identify non-optimal MR fluid behavior.

10. A magnetorheological (MR) fluid device comprising:
a magnetorheological (MR) fluid;
an inductor coil configured to apply a magnetic field to the MR fluid;
a low frequency operating signal generator module;
a high frequency operating signal generator module;
a circuit configured to apply a mixed-frequency signal to the inductor coil, wherein the mixed-frequency signal includes an operating signal component at a first frequency that is configured to generate the magnetic field to control viscosity of the MR fluid, and wherein the mixed-frequency signal includes a diagnostic signal at a second frequency, wherein the second frequency is higher than the first frequency;
a current detector configured to measure a current flowing through the inductor coil;
a high pass filter configured to filter out a high frequency component of the current; and
a module for monitoring impedance of the high frequency component of the current to identify non-optimal MR fluid behavior.

11. The device of claim 10, wherein the non-optimal MR fluid behavior is a loss of MR fluid.

12. The device of claim 10, wherein the non-optimal MR fluid behavior is cavitation of the MR fluid.

13. The device of claim 10, wherein the first frequency operating signal component is less than 5 kHz; and the second frequency of the diagnostic signal is greater than 10 kHz.

14. The device of claim 10, wherein the module for monitoring impedance of the high frequency component of the current to identify non-optimal MR fluid behavior is configured to compare a response to a baseline value.

15. The device of claim 10, wherein the module for monitoring impedance of the high frequency component of the current to identify non-optimal MR fluid behavior is configured to determine whether the impedance matches an expected response.

16. The device of claim 15, wherein the module for monitoring impedance of the high frequency component of the current to identify non-optimal MR fluid behavior is configured to generate the expected response based on system information selected from position, speed, current, and temperature.

17. The device of claim 10, wherein the module for monitoring impedance of the high frequency component of the current to identify non-optimal MR fluid behavior is configured to:
determine that the impedance does not match an expected response;
add a count to a count total;
determine that the count total meets threshold; and
signal to an operator that a potential fault exists in the MR fluid device.

18. The device of claim 10, wherein the module for monitoring impedance of the high frequency component of the current to identify non-optimal MR fluid behavior is configured to:
determine that the impedance does not match an expected response;
add a count to a count total;
determine that the count total does not meet threshold; and
continue monitoring impedance of the high frequency component of the current to identify non-optimal MR fluid behavior.

19. A vehicle comprising:
a magnetorheological (MR) fluid device including a magnetorheological (MR) fluid; an inductor coil configured to apply a magnetic field to the MR fluid; a low frequency operating signal generator module; a high frequency operating signal generator module; a circuit configured to apply a mixed-frequency signal to the inductor coil, wherein the mixed-frequency signal includes an operating signal component at a first frequency that is configured to generate the magnetic field to control viscosity of the MR fluid, and wherein the mixed-frequency signal includes a diagnostic signal at a second frequency, wherein the second frequency is higher than the first frequency; a current detector configured to measure a current flowing through the inductor coil; a high pass filter configured to filter out a high frequency component of the current; and a module for monitoring impedance of the high frequency component of the current to identify non-optimal MR fluid behavior.

20. The vehicle of claim 19, wherein the MR fluid device is a damper.
